(19) United States
(12) Patent Application Publication
(10) Pub. No.: US 2013/0138683 A1
(43) Pub. Date: May 30, 2013

(54) SYSTEMS AND METHODS OF AUTOMATIC GENERATION AND EXECUTION OF DATABASE QUERIES

(71) Applicants: Yakov Faitelson, Elkana (IL); Ohad Korkus, Herzeliya (IL); Ophir Kretzer-Katzir, Reut (IL)

(72) Inventors: Yakov Faitelson, Elkana (IL); Ohad Korkus, Herzeliya (IL); Ophir Kretzer-Katzir, Reut (IL)

(21) Appl. No.: 13/377,877

(22) PCT Filed: Nov. 24, 2011
(86) PCT No.: PCT/IL2011/000901

§ 371 Date: Mar. 15, 2012

(51) Int. Cl. G06F 17/30

(52) U.S. Cl. 707/769; 707/E17.014

(57) ABSTRACT

There is thus provided in accordance with a preferred embodiment of the present invention a system for automatically generating and executing database queries, the system including a user interface operative to allow a user to select at least one selected predefined database report from a list of predefined database reports and automatic database query generation functionality operative to automatically generate a database query corresponding to the at least one selected predefined database report, the database query including at least one predefined combinable page.

REFERENCE TO RELATED APPLICATIONS

Reference is made to the following patents and patent applications, owned by assignee, the disclosures of which are hereby incorporated by reference:

U.S. Pat. Nos.: 7,555,482 and 7,606,801;

U.S. Published Patent Application Nos.: 2007/0244899, 2008/0271157, 2009/0100058, 2009/0119298; 2009/0265780; 2011/0010758; 2011/0060916; 2011/0061093; 2011/0061111 and 2011/0184989; and;

U.S. patent application Ser. Nos.: 12/861,059; 12/861,953 and 13/106,023; 13/159,903.

### FIELD OF THE INVENTION

The present invention relates to systems and methods of automatic generation and execution of database queries.

### BACKGROUND OF THE INVENTION

The following patent publications are believed to represent the current state of the art:

U.S. Pat. No.: 5,546,455; and

U.S. Published Patent Application Nos.: 2005/0102284 and 2006/0155689.

### SUMMARY OF THE INVENTION

The present invention provides systems and methods of automatic generation and execution of database queries.

There is thus provided in accordance with a preferred embodiment of the present invention a system for automatically generating and executing database queries, the system including a user interface operative to allow a user to select at least one selected predefined database report from a list of predefined database reports and automatic database query generation functionality operative to automatically generate a database query corresponding to the at least one selected predefined database report, the database query including at least one predefined combinable page.

Preferably, the user interface also allows the user to define at least one database query filter. Preferably, the system also includes automatic database query execution functionality operative to execute the database query on at least one database. Preferably, the automatic database query execution functionality is also operative to apply the at least one database query filter to the results of the execution of the database query.

Preferably, the at least one database resides on a computer server connected to an enterprise network. Preferably, the user interface is also operative to display the results of the execution of the database query to the user. Preferably, the user interface is also operative to display the results of the application of the at least one database query filter to the results to the user.

There is also provided in accordance with another preferred embodiment of the present invention a method for automatically generating and executing database queries, the method including allowing a user to select at least one selected predefined database report from a list of predefined database reports and automatically generating a database query corresponding to the at least one selected predefined database report, the database query including at least one predefined combinable page.

Preferably, the method also includes allowing the user to define at least one database query filter. Preferably, the method also includes executing the database query on at least one database. Preferably, the method also includes applying the at least one database query filter to the results of the execution of the database query.

Preferably, the at least one database resides on a computer server connected to an enterprise network. Preferably, the method also includes displaying the results of the execution of the database query to the user. Preferably, the method also includes displaying the results of the application of the at least one database query filter to the results to the user.

### BRIEF DESCRIPTION OF THE DRAWINGS

The present invention will be understood and appreciated more fully from the following detailed description, taken in conjunction with the drawings in which:

FIG. 1 is a simplified pictorial illustration of one example of the use of a system for automatically generating and executing database queries, constructed and operative in accordance with a preferred embodiment of the present invention; and

FIGS. 2A and 2B are together a simplified flowchart indicating steps in one example of the operation of the system of FIG. 1.

### DETAILED DESCRIPTION OF PREFERRED EMBODIMENTS

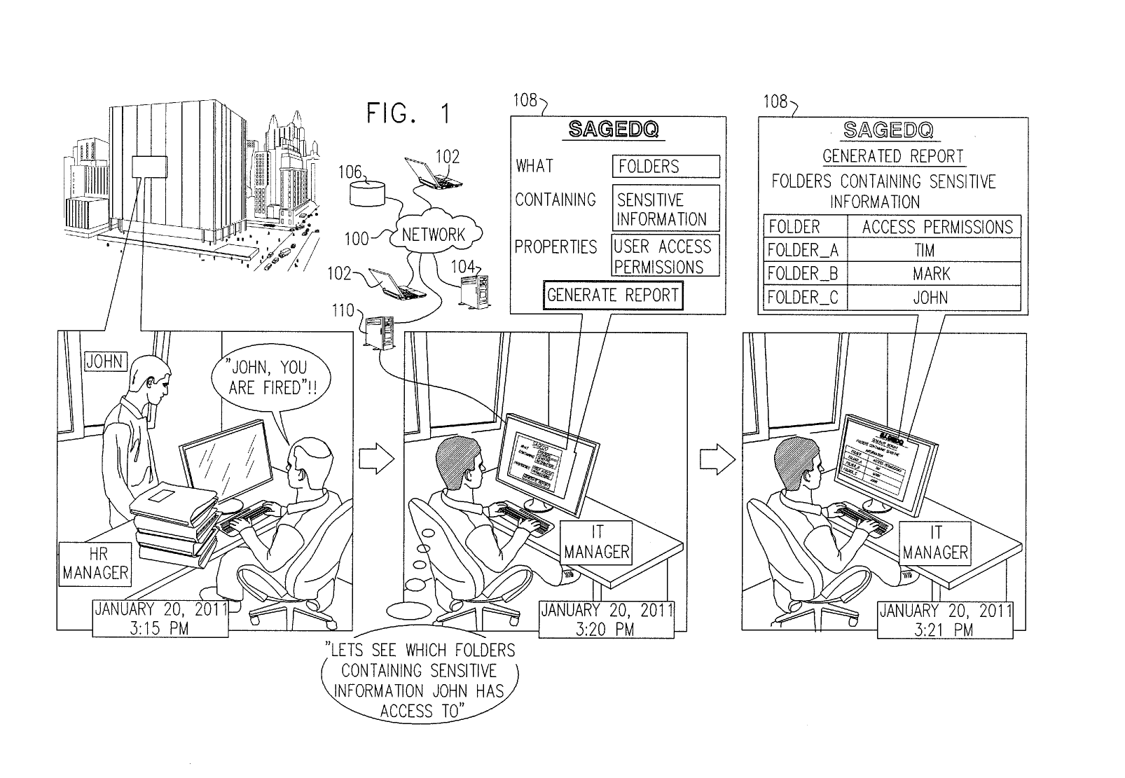

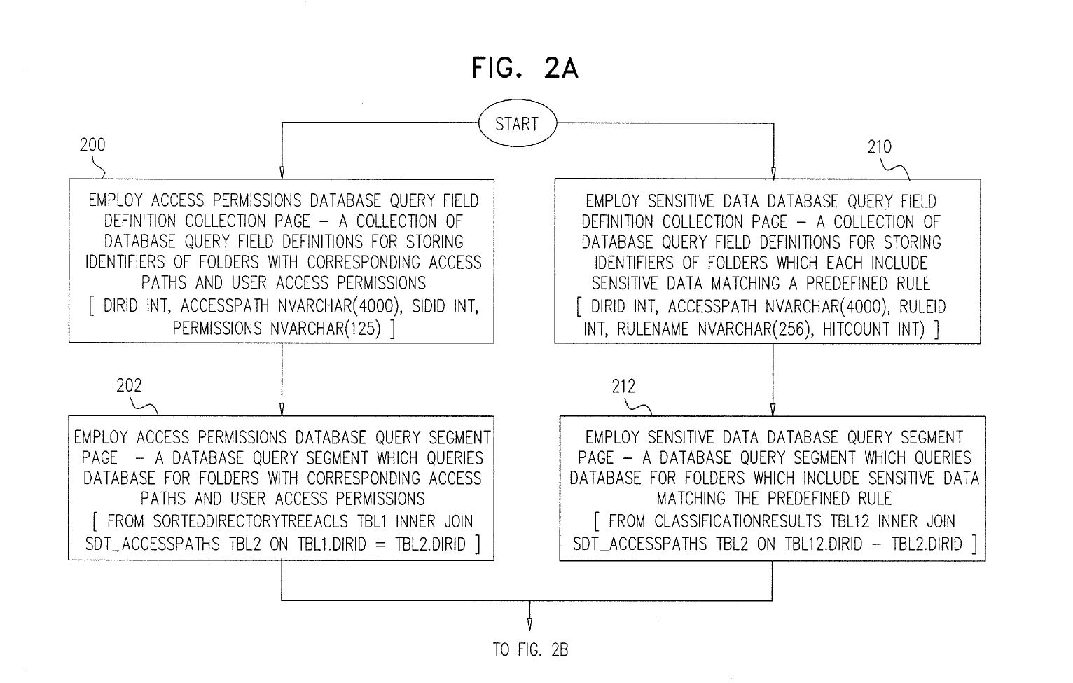

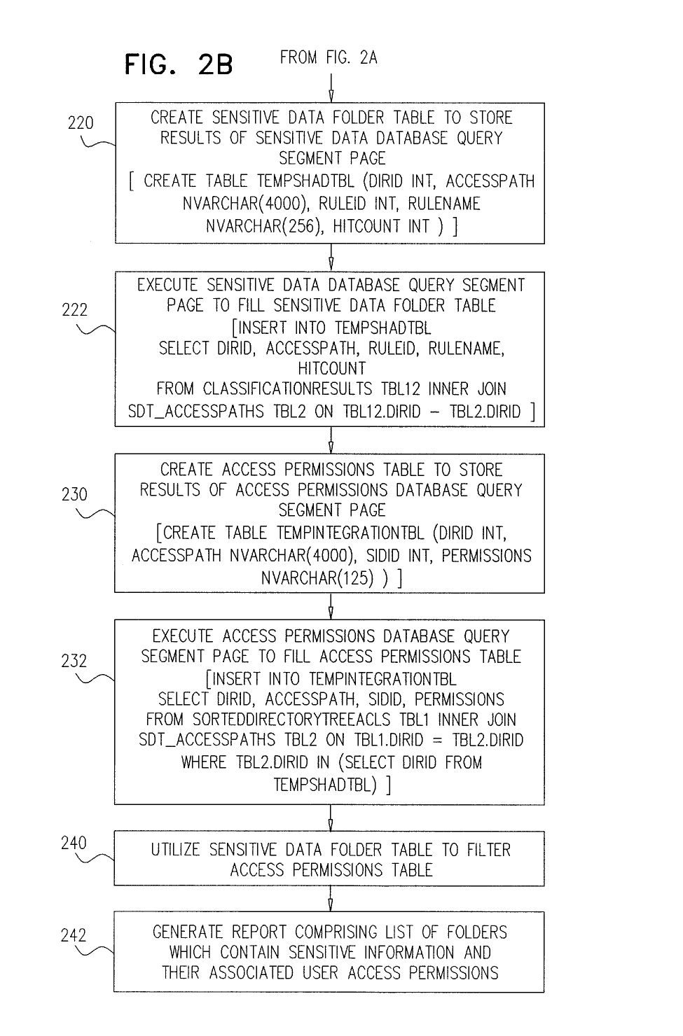

Reference is now made to FIG. 1, which is a simplified pictorial illustration of one example of the use of a system for automatically generating and executing database queries, constructed and operative in accordance with a preferred embodiment of the present invention, and to FIGS. 2A and 2B, which are together a simplified flowchart indicating steps in one example of the operation of the system of FIG. 1. The system for automatically generating and executing database queries (SAGEDQ) of FIGS. 1-2B is preferably suitable for operating in an enterprise computer network including multiple disparate computer hardware and software resources, data elements such as files and folders and database systems accessible by at least one database query language.

The SAGEDQ preferably includes a user interface operative to allow a user to select at least one predefined database report from a list of predefined database reports and automatic database query generation functionality operative to automatically generate a database query corresponding to the at least one selected predefined database report, the database query comprising at least one predefined combinable page. The term “page” for the purposes of this application is defined as either a collection of database query field definitions or a database query segment.

Preferably, the system also includes automatic database query execution functionality operative to execute the database query on at least one database. Preferably, the user interface also allows the user to define at least one database query filter, and the automatic database query execution functionality is operative to apply the at least one database query filter to the results of the execution of the database query.

As shown in the example of FIG. 1, at a particular time, such as on Jan. 20, 2011 at 3:15 PM, an HR manager of a company notifies John, an employee of the company, that his employment with the company is terminated. Shortly thereafter, such as at 3:20 PM, the IT manager of the enterprise network 100 of the company wishes to ascertain which folders containing sensitive information does John have access permissions to. Network 100 preferably includes disparate computers 102, file servers 104, and databases 106.

As seen in FIG. 1, the IT manager accesses a SAGEDQ user interface 108 of a SAGEDQ system which preferably resides on a server 110 connected to network 100 to select and generate a database report which comprises a list of folders in the organization and the user access permissions associated which each of the folders. The IT manager then also selects to filter the results of the database report to include only folders comprising sensitive data.

As further shown in FIG. 1, after instructing the SAGEDQ to generate the selected report, the IT manager receives a list of folders containing sensitive information and their associated user access permissions. The IT manager can then further filter the results of the selected report to ascertain to which of the folders John has access permissions to.

It is a particular feature of the present invention that for each predefined database report the SAGEDQ is operative to employ a unique combination of predefined combinable pages which together form a database query corresponding to the report. Each such database query comprises at least one database query field definition collection page and at least one database query segment page.

The flowchart of FIGS. 2A & 2B illustrates the steps in forming a database query which corresponds to the report selected by the IT manager in the example of FIG. 1. It is appreciated that the syntax of the database queries and pages shown in FIGS. 2A & 2B is for the purpose of illustration, however actual database queries and pages may be generated by the SAGEDQ in any suitable database query language.

As shown in FIG. 2A, the system initially employs an access permissions database query field definition collection page comprising a collection of database query field definitions suitable for storing a table of folders with their corresponding access paths and user access permissions (200). The system then employs an access permissions database query segment page which queries a database for a list of folders with their corresponding access paths and user access permissions (202).

The system also employs a sensitive data database query field definition collection page comprising a collection of database query field definitions suitable for storing a table of folders which each include at least one string of sensitive data matching a predefined rule (210). The system then employs a sensitive data database query segment page which queries a database for a list of folders which each include at least one string of sensitive data matching the predefined rule (212).

Subsequently, as shown in FIG. 2B, the system executes the access permissions database query segment page and the sensitive data database query segment page to execute the report requested by the IT manager in the example of FIG. 1. It is appreciated that each of the pages employed by the SAGEDQ may be used to query disparate databases.

As shown in FIG. 2B, to execute the report, the SAGEDQ first creates a sensitive data folder table to store the results of the execution of the sensitive data database query segment page (220) and executes the sensitive data database query segment page, thereby filling the sensitive data folder table (222).

The SAGEDQ then creates an access permissions table to store the results of the execution of the access permissions database query segment page (230) and executes the access permissions database query segment page, thereby filling the access permissions table (232).

Thereafter, the SAGEDQ utilizes the sensitive data folder table to filter the access permissions table (240), thereby generating a report comprising a list of folders which contain sensitive information and their associated user access permissions (242). It is appreciated that the report can be further similarly filtered according to any suitable parameter, such as, for example, folders having access permissions to a particular user, folder size and last modification date.

It will be appreciated by persons skilled in the art that the present invention is not limited by what has been particularly shown and described hereinabove. Rather the scope of the present invention includes both combinations and subcombinations of the various features described hereinabove as well as modifications thereof which would occur to persons skilled in the art upon reading the foregoing description and which are not in the prior art.

1. A system comprising a non-transitory, tangible computer-readable medium in which computer program instructions are stored, which instructions, when read by a computer, cause the computer to automatically generate and execute database queries, said system comprising:
a user interface operative to allow a user to select at least one selected predefined database report from a list of predefined database reports; and
automatic database query generation functionality operative to automatically generate a database query corresponding to said at least one selected predefined database report, said database query comprising a combination of a multiplicity of predefined combinable pages, wherein at least one of said multiplicity of predefined combinable pages is used to query multiple disparate databases.

2. A system for automatically generating and executing database queries according to claim 1 and wherein said user interface also allows said user to define at least one database query filter.

3. A system for automatically generating and executing database queries according to claim 2 and also comprising:
automatic database query execution functionality operative to execute said database query on at least one database.

4. A system for automatically generating and executing database queries according to claim 3 and wherein said automatic database query execution functionality is also operative to apply said at least one database query filter to the results of said execution of said database query.

5. A system for automatically generating and executing database queries according to claim 4 and wherein said at least one database resides on a computer server connected to an enterprise network.

6. A system for automatically generating and executing database queries according to claim 3 and wherein said user interface is also operative to display the results of said execution of said database query to said user.

7. A system for automatically generating and executing database queries according to claim 4 and wherein said user interface is also operative to display the results of said application of said at least one database query filter to said results to said user.

8. A method for automatically generating and executing database queries, said method comprising:
allowing a user to select at least one selected predefined database report from a list of predefined database reports; and
automatically generating a database query corresponding to said at least one selected predefined database report, said database query comprising a combination of a multiplicity of predefined combinable pages, wherein at least one of said multiplicity of predefined combinable pages is used to query multiple disparate databases.

9. A method for automatically generating and executing database queries according to claim 8 and also comprising allowing said user to define at least one database query filter.

10. A method for automatically generating and executing database queries according to claim 9 and also comprising executing said database query on at least one database.

11. A method for automatically generating and executing database queries according to claim 10 and also comprising applying said at least one database query filter to the results of said execution of said database query.

12. A method for automatically generating and executing database queries according to claim 11 and wherein said at least one database resides on a computer server connected to an enterprise network.

13. A method for automatically generating and executing database queries according to claim 10 and also comprising displaying the results of said execution of said database query to said user.

14. A method for automatically generating and executing database queries according to claim 11 and also comprising displaying the results of said application of said at least one database query filter to said results to said user.

15. A system for automatically generating and executing database queries according to claim 1 and wherein each of said multiplicity of predefined combinable pages is used to query multiple disparate databases.

16. A system for automatically generating and executing database queries according to claim 1 and wherein said system initially creates a table to store results of execution of a database query page and executes the database query page, thereby filling said table.

17. A system for automatically generating and executing database queries according to claim 15 and wherein said system initially creates a table to store results of execution of a database query page and executes the database query page, thereby filling said table.

18. A system for automatically generating and executing database queries according to claim 1 and wherein said system initially creates a multiplicity of tables to store results of execution of multiple database query pages and executes the database query pages, thereby filling said multiplicity of tables.

19. A system for automatically generating and executing database queries according to claim 15 and wherein said system initially creates a multiplicity of tables to store results of execution of multiple database query pages and executes the database query pages, thereby filling said multiplicity of tables.

20. A method for automatically generating and executing database queries according to claim 8 and wherein each of said multiplicity of predefined combinable pages is used to query multiple disparate databases.

21. A method for automatically generating and executing database queries according to claim 8 and also comprising initially creating a table to store results of execution of a database query page and executing the database query page, thereby filling said table.

22. A method for automatically generating and executing database queries according to claim 20 and also comprising initially creating a table to store results of execution of a database query page and executing the database query page, thereby filling said table.

23. A method for automatically generating and executing database queries according to claim 8 and also comprising initially creating a multiplicity of tables to store results of execution of multiple database query pages and executing the database query pages, thereby filling said multiplicity of tables.

24. A method for automatically generating and executing database queries according to claim 20 and also comprising initially creating a multiplicity of tables to store results of execution of multiple database query pages and executing the database query pages, thereby filling said multiplicity of tables.
